(19) United States
(12) Patent Application Publication
(10) Pub. No.: US 2025/0121764 A1
(43) Pub. Date: Apr. 17, 2025

(54) TRAILER SYSTEM FOR SECURING TRANSPORT OF FINISHED AUTOMOBILES

(71) Applicant: Schneider Enterprise Resources, LLC, Green Bay, WI (US)

(72) Inventor: Gary Jashinsky, Coleman, WI (US)

(73) Assignee: Schneider Enterprise Resources, LLC, Green Bay, WI (US)

(21) Appl. No.: 18/915,072

(22) Filed: Oct. 14, 2024

Related U.S. Application Data
(60) Provisional application No. 63/590,686, filed on Oct. 16, 2023.

(51) Int. Cl. B60P 3/077; B60P 3/079

(52) U.S. Cl. CPC B60P 3/077; B60P 3/079

(57) ABSTRACT

An automobile securing system for securing an automobile inside a container of a truck includes a front bracing assembly coupled to a bottom wall of the container and configured to secure a front wheel of the automobile inside the container. The front bracing assembly includes a strap configured to wrap around the front wheel, a base block and a clamping block configured to be positioned in front of the front wheel and secure a portion of the strap therebetween, a front wheel brace configured to engage the front wheel and a side wall of the container and positioned to prevent forward movement of the automobile, and a front wheel side brace positioned to prevent lateral movement of the automobile.

### CROSS-REFERENCE TO RELATED PATENT APPLICATION

This application claims the benefit of and priority to U.S. Provisional Patent Application No. 63/590,686, filed Oct. 16, 2023, which is incorporated herein by reference in its entirety.

### BACKGROUND

This application generally relates to the transportation of automobiles. Automobile transportation enables automobile manufacturers to deliver finished automobiles from a manufacturing facility to automobile dealerships and end consumers.

### SUMMARY

One embodiment relates to an automobile securing system for securing an automobile inside a container of a vehicle. The automobile securing system includes a front bracing assembly and a rear bracing assembly. The front bracing assembly is configured to couple to a bottom wall of the container. The front bracing assembly is configured to secure a front wheel of the automobile inside the container. The front bracing assembly includes a strap configured to wrap around the front wheel, a base block and a clamping block configured to be positioned in front of the front wheel and secure a portion of the strap therebetween, a front wheel brace configured to engage the front wheel and a side wall of the container and be positioned to prevent forward movement of the automobile, and a front wheel side brace configured to be positioned to prevent lateral movement of the automobile. The rear bracing assembly is configured to couple to the bottom wall of the container. The rear bracing assembly is configured to secure a rear wheel of the automobile inside the container. The rear bracing assembly includes a rear wheel brace configured to engage the rear wheel and the side wall of the container and be positioned to prevent rearward movement of the automobile, a rear wheel side brace configured to be positioned to prevent lateral movement of the automobile, a backup cleat configured to engage a rear side of the rear wheel brace, and a cross brace configured to couple the rear wheel brace, the rear wheel side brace, and the backup cleat together.

Another embodiment relates to a method for securing a finished automobile inside a container being transported by a truck. The method includes providing a set of front bracing assemblies including straps, base blocks, front wheel braces, clamping blocks, and front wheel side braces, providing a set of rear bracing assemblies including rear wheel braces, rear wheel side braces, backup cleats, and cross braces, laying the straps longitudinally along a bottom wall of the container such that the straps are laterally spaced a distance apart based on a wheel track of the finished automobile, placing the base blocks on top of the straps, placing the front wheel braces laterally across the straps, the front wheel braces engaging rear ends of the base blocks and side walls of the container, loading the finished automobile into the container such that front wheels of the finished automobile engage with the front wheel braces, wrapping free ends of the straps around an outer circumference of the front wheels with the free ends of the straps extending at least partially along upper surfaces of the base blocks, placing the clamping blocks on top of the free ends of the straps to secure the straps between the base blocks and the clamping blocks, placing the front wheel side braces along an outside surface of the front wheels, placing the rear wheel braces laterally behind rear wheels of the finished automobile, the rear wheel braces engaging the rear wheels and the side walls of the container, placing the rear wheel side braces along an outside surface of the rear wheels forward of and in engagement with front sides of the rear wheel braces, placing the backup cleats rearward of and in engagement with rear sides of the rear wheel braces, and coupling the rear wheel braces, the rear wheel side braces, and the backup cleats together using the cross braces.

Still another embodiment relates to an automobile securing system for securing an automobile inside a container of a vehicle. The automobile securing system includes a plurality of front bracing assemblies and a plurality of rear bracing assemblies. The plurality of front bracing assemblies are configured to couple to a bottom wall of the container. The plurality of front bracing assemblies are configured to secure front wheels of the automobile inside the container. Each of the plurality of front bracing assemblies includes a strap configured to wrap around a respective front wheel of the front wheels, the strap including a first portion and a second portion, a base block and a clamping block configured to be positioned in front of the respective front wheel and secure the first portion of the strap therebetween, the base block configured to be positioned on top of the second portion of the strap, and a front wheel brace configured to engage the front wheel and be positioned to prevent forward movement of the automobile. The plurality of rear bracing assemblies are configured to couple to the bottom wall of the container. The rear plurality of bracing assemblies are configured to secure rear wheels of the automobile inside the container. Each of the plurality of rear bracing assemblies includes a rear wheel brace configured to engage a respective rear wheel of the rear wheels and be positioned to prevent rearward movement of the automobile, a backup cleat configured to engage a rear side of the respective rear wheel brace, and a cross brace configured to couple the rear wheel brace, the rear wheel side brace, and the backup cleat together.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a front, left perspective view of an automobile transportation vehicle including a container, according to an exemplary embodiment.

FIG. 2 is an interior top view of the container of FIG. 1 with finished automobiles secured therein using an automobile securing system including front bracing assemblies and rear bracing assemblies, according to an exemplary embodiment.

FIG. 3 is an interior side view of the container of FIG. 2 with finished automobiles secured therein using the automobile securing system, according to an exemplary embodiment.

FIGS. 4-9 are various side views illustrating a process by which various components of the front bracing assemblies of the automobile securing system of FIGS. 2 and 3 are installed within the container, according to an exemplary embodiment.

FIGS. 10-13 are various side views illustrating a process by which various components of the rear bracing assemblies of the automobile securing system of FIGS. 2 and 3 are installed within the container, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Vehicle Configuration

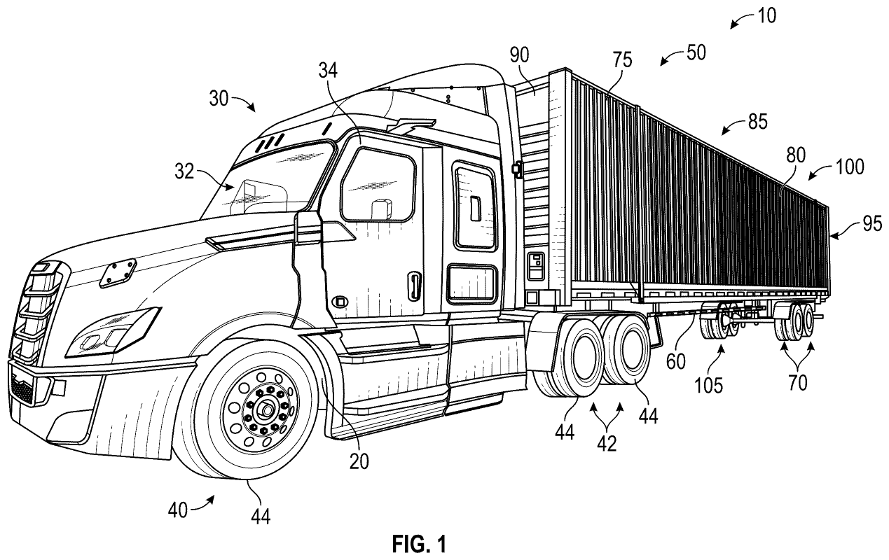

As shown in FIG. 1, an automobile transportation vehicle (e.g., a vehicle assembly, a truck, etc.), shown as vehicle 10, is configured as a truck (e.g., a semi-tractor or semi-truck, such as a truck configured to haul a trailer partially or fully filled with cargo). The vehicle 10 includes a frame assembly or chassis assembly, shown as chassis 20, that supports other components of the vehicle 10. The chassis 20 extends longitudinally along a length of the vehicle 10, substantially parallel to a primary direction of travel of the vehicle 10. In some embodiments, the chassis 20 includes a pair of frame rails that extend along a length of the vehicle 10. In other embodiments, the chassis 20 is otherwise configured (e.g., as a single, continuous piece, etc.).

As shown in FIG. 1, a cabin or operator compartment, shown as cab 30, is coupled to a front end portion of the chassis 20. Together, the chassis 20 and the cab 30 define a front end of the vehicle 10. The cab 30 extends above the chassis 20. The cab 30 includes an enclosure or main body that defines an interior volume, shown as cab interior 32, that is sized to accommodate one or more operators. The cab 30 also includes one or more doors 34 that facilitate selective access to the cab interior 32 from outside of the vehicle 10. The cab interior 32 contains one or more components that facilitate operation of the vehicle 10 by the operator. By way of example, the cab interior 32 may contain components that facilitate operator comfort (e.g., seats, seatbelts, etc.), user interface components that receive inputs from the operators (e.g., steering wheels, pedals, touch screens, switches, buttons, levers, etc.), and/or user interface components that provide information to the operators (e.g., lights, gauges, speakers, etc.). The user interface components within the cab 30 may facilitate operator control over the drive components of the vehicle 10 and/or over any implements of the vehicle 10.

As shown in FIG. 1, the vehicle 10 includes a series of axle assemblies or drive assemblies, shown as front axle 40 and rear axles 42. As shown, the vehicle 10 includes one front axle 40 coupled to the chassis 20 near a front end of the vehicle 10 and two rear axles 42 (e.g., a tandem rear axle) coupled to the chassis 20 near a rear end of the vehicle 10. In other embodiments, the vehicle 10 includes more or fewer axles (e.g., one rear axle 42). The front axle 40 and the rear axles 42 each include a plurality of tractive elements (e.g., wheels, treads, etc.), shown as wheel and tire assemblies 44. The wheel and tire assemblies 44 are configured to engage a support surface (e.g., roads, the ground, etc.) to support and propel the vehicle 10. The front axle 40 and the rear axle 42 may include steering components (e.g., steering arms, steering actuators, etc.), suspension components (e.g., gas springs, dampeners, air springs, etc.), power transmission or drive components (e.g., differentials, drive shafts, etc.), braking components (e.g., brake actuators, brake pads, brake discs, brake drums, etc.), and/or other components that facilitate propulsion or support of the vehicle 10.

As shown in FIG. 1, the vehicle 10 includes a rear assembly, module, implement, body, or cargo area, or application kit, shown as trailer 50, coupled to a rear end of the vehicle 10. The trailer 50 includes a chassis, shown as trailer frame 60, a plurality of axles and wheel assemblies, shown as trailer axles 70, coupled to the trailer frame 60, and a rear body or cargo container (e.g., an International Organization for Standardization (ISO) container, an intermodal (IM) container, shipping container, etc.), shown as container 75, coupled to the trailer frame 60. The container 75 may be closed or open to the environment. The container 75 is configured to store cargo (e.g., cars, equipment, etc.) during transportation. According to an exemplary embodiment, the container 75 is an ISO container or an IM container that is removable from the trailer frame 60. In other embodiments, the container 75 is fixed to the trailer frame 60.

As shown in FIG. 1, the container 75 includes opposing sidewalls, shown as left wall 80 and right wall 85. The left wall 80 and the right wall 85 are vertically oriented and are laterally offset from one another. The container 75 includes opposing end walls, shown as front wall 90 and rear wall 95. The front wall 90 and the rear wall 95 are vertically oriented and are longitudinally offset from one another. The front wall 90 and the rear wall 95 extend in a lateral direction between the left wall 80 and the right wall 85. The container 75 includes a top wall 100 and a bottom wall 105 that are horizontally oriented and are vertically offset from one another. The top wall 100 and the bottom wall 105 extend in (i) a lateral direction between the left wall 80 and the right wall 85 and (ii) a longitudinal direction between the front wall 90 and the rear wall 95. Collectively, the left wall 80, the right wall 85, the front wall 90, the rear wall 95, the top wall 100, and the bottom wall 105 define an interior volume (e.g., storage volume, cargo volume, interior chamber, etc.) of the container 75, shown as interior volume 110.

According to an exemplary embodiment, the container 75 includes a door positioned at a rear end of the container 75 that facilitates selective access to the interior volume 110 of the container 75. In some embodiments, the rear wall 95 is configured as one or more doors. In some embodiments, the door is otherwise positioned about sides of the container 75 to facilitate selective access to the interior volume 110 of the container 75. The container 75 may include a ramp to facilitate loading and unloading cargo from the vehicle 10. By way of example, the ramp may provide a surface to drive (e.g., guide, direct, load, unload, etc.) a vehicle (e.g., an automobile 200) to be stored inside the interior volume 110.

In some embodiments, the container 75 is sized according to standardized ISO container dimensions including: (i) an external longitudinal length between exterior surfaces of the front wall 90 and the rear wall 95 of 53 feet and an internal longitudinal length between interior surfaces of the front wall 90 and the rear wall 95 of 52 feet 6 inches, (ii) an external lateral width between exterior surfaces of the left wall 80 and the right wall 85 of 8 feet 6 inches and an internal lateral width between interior surfaces of the left wall 80 and the right wall 85 of 8 feet 2 inches, and (iii) an external vertical height between exterior surfaces of the top wall 100 and the bottom wall 110 of 9 feet 6 inches and an internal vertical height between interior surfaces of the top wall 100 and the bottom wall 105 of 8 feet 11 inches. In such embodiments, the door defines an 8 foot 2 inch lateral width and an 8 foot 10 inch vertical height. In other embodiments, the container 75 (and the door) is a different size or dimension. The dimensions of the container 75 may vary depending on the cargo stored in the container 75 and the intended application of the vehicle 10.

### Automobile Securing System

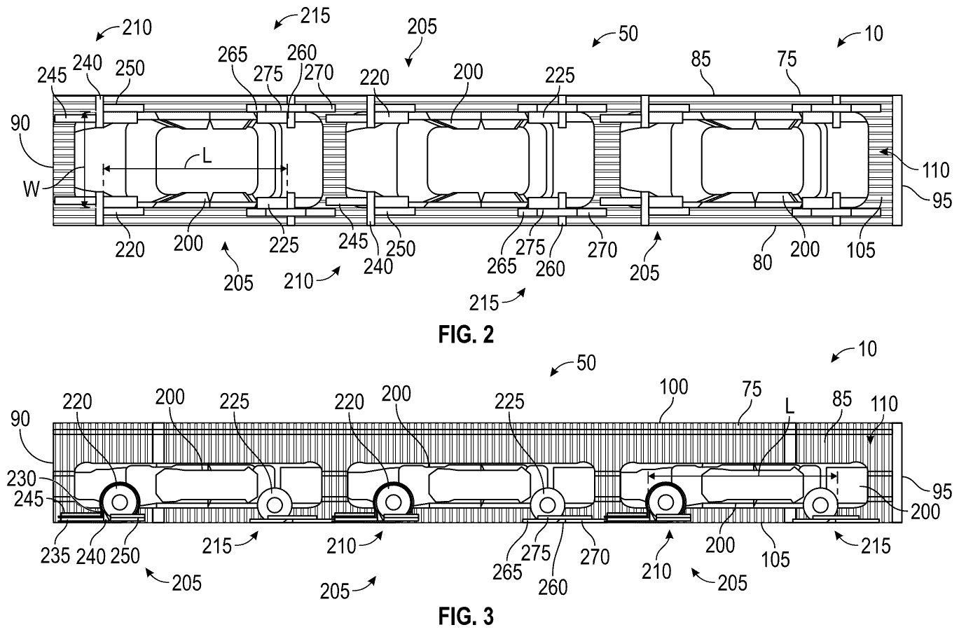

As shown in FIGS. 2 and 3, the interior volume 110 of the container 75 is configured to receive and store one or more automobiles (e.g., motor vehicles, trucks, passenger vehicles, sedans, sport utility vehicles (SUVs), etc.), shown as automobiles 200. In some embodiments, the interior volume 110 of the container 75 is configured to store more or fewer than the three automobiles 200 shown in FIGS. 2 and 3 (e.g., depending on the size of the automobiles 200 or the size of the container 75).

As shown in FIGS. 2 and 3, the automobiles 200 are secured (e.g., coupled, tied down, etc.) to the container 75 using a securing system, shown as automobile securing system 205. The automobile securing system 205 is configured to selectively secure one or more automobiles 200 within the container 75 such that, during transportation thereof using the vehicle 10, the automobiles 200 are substantially prevented (e.g., inhibited) from moving (e.g., sliding, rolling, etc.) in a lateral, longitudinal, and/or vertical direction within the interior volume 110. By securing the automobiles 200 within the container 75, the automobile securing system 205 substantially prevents the automobiles 200 from contacting the walls of the container 75, other automobiles 200 within the container 75, and/or any other cargo being stored inside the container 75. By way of example, the automobiles 200 may be finished automobiles (e.g., fully assembled, painted, etc.) being shipped by a manufacturer to a car dealership, reseller, customer, end consumer, etc. In such an example, the automobile securing system 205 prevents the automobiles 200 from being scratched, damaged, dented, etc. while being transported.

As shown in FIGS. 2 and 3, the automobile securing system 205 includes a front bracing system including a set of first bracing assemblies (e.g., blocks, supports, wedges, chocks, straps, etc.), shown as front bracing assemblies 210, and a rear bracing system including a set of second bracing assemblies (e.g., blocks, supports, wedges, chocks, straps, etc.), shown as rear bracing assemblies 215. According to an exemplary embodiment, the front bracing assemblies 210 are configured to rigidly couple to the bottom wall 105 (or a floor surface thereon) of the container 75 and configured to selectively and releasably secure a first set of wheels (e.g., front left and right wheels, tractive elements, tires, etc.), shown as front wheels 220, of the automobiles 200, to the bottom wall 105 (or the floor surface thereon). Similarly, the rear bracing assemblies 215 are configured to rigidly couple to the bottom wall 105 (or the floor surface thereon) of the container 75 and configured to selectively secure a second set of wheels (e.g., rear left and right wheels, tractive elements, tires, etc.), shown as rear wheels 225, of the automobiles 200, to the bottom wall 105 (or the floor surface thereon). Collectively, the front bracing assemblies 210 and the rear bracing assemblies 215 substantially prevent lateral, longitudinal, and vertical movement of the automobiles 200 during transportation by the vehicle 10. Each set of front bracing assemblies 210 and rear bracing assemblies 215 are configured to secure one automobile 200 within the interior volume 110. In some embodiments, the automobile securing system 205 does not include the rear bracing assemblies 215.

As shown in FIGS. 2 and 3, the front bracing assemblies 210 are laterally spaced a distance W from one another. The distance W is defined as the lateral length extending between an outside edge of the left front wheel 220 and an outside edge of the right front wheel 220. Similarly, the rear bracing assemblies 215 are laterally spaced the distance W. In some embodiments, the distance extending between the outside edges of the left and right front wheels 220 (e.g., distance W) is different than the distance extending between an outside edge of the left rear wheel 225 and an outside edge of the right rear wheel 225. In such embodiments, the rear bracing assemblies 215 are spaced apart the extending between the outside edge of the left and right rear wheels 225. The front bracing assemblies 210 are longitudinally spaced a distance L from the rear bracing assemblies 215. The distance L is defined as the longitudinal length between a front edge of the front wheels 220 and a rear edge of the rear wheels 225.

As shown in FIGS. 2 and 3, the automobile securing system 205 includes three sets of front bracing assemblies 210 and three sets of rear bracing assemblies 215 to secure three automobiles 200 within the interior volume 110 of the container 75. In some embodiments, the sets of front bracing assemblies 210 and rear bracing assemblies 215 are longitudinally spaced within the container 75 such that the bumper-to-bumper spacing between the automobiles 200 (e.g., the spacing between a rear bumper of a first automobile 200 and a front bumper of a second automobile 200) and/or the bumper-to-front-or-rear-wall spacing (e.g., the spacing between a front bumper of a forward-most automobile 200 and the interior surface of the front wall 90, the spacing between a rear bumper of a rearward-most automobile 200 and the interior surface of the rear wall 95) is about 18 inches. In other embodiments, the sets of front bracing assemblies 210 and rear bracing assemblies 215 are otherwise longitudinally spaced (e.g., 12 inches, 6 inches, 24 inches, etc.) from one another and from the walls defining the interior volume 110 such that, during transportation, an automobile 200 secured by a set of front bracing assemblies 210 and rear bracing assemblies 215 is prevented from contacting any other automobile 200 and/or the walls defining the interior volume 110.

In some embodiments, the automobile securing system 205 includes more or fewer than three sets of front bracing assemblies 210 and rear bracing assemblies 215. In some embodiments, the automobile securing system 205 includes a number of sets of front bracing assemblies 210 and rear bracing assemblies 215 that is equal to the number of automobiles 200 that the container 75 is configured to store. By way of example, if the container 75 can store and transport three automobiles 200, the automobile securing system 205 includes three sets of front bracing assemblies 210 and rear bracing assemblies 215. By way of another example, if the container 75 can store and transport four automobiles 200, the automobile securing system 205 includes four sets of front bracing assemblies 210 and rear bracing assemblies 215.

In some embodiments, the distance L varies depending on the length of the wheelbase of the automobile 200. In such embodiments, the automobile securing system 205 may be configured to facilitate securing one or more automobiles 200 each having the same or different lengths. Similarly, in some embodiments, the distance W varies depending on the width of the wheel track of the automobile 200. In such embodiments, the automobile securing system 205 may be configured to facilitate securing one or more automobiles 200 each having the same or different widths.

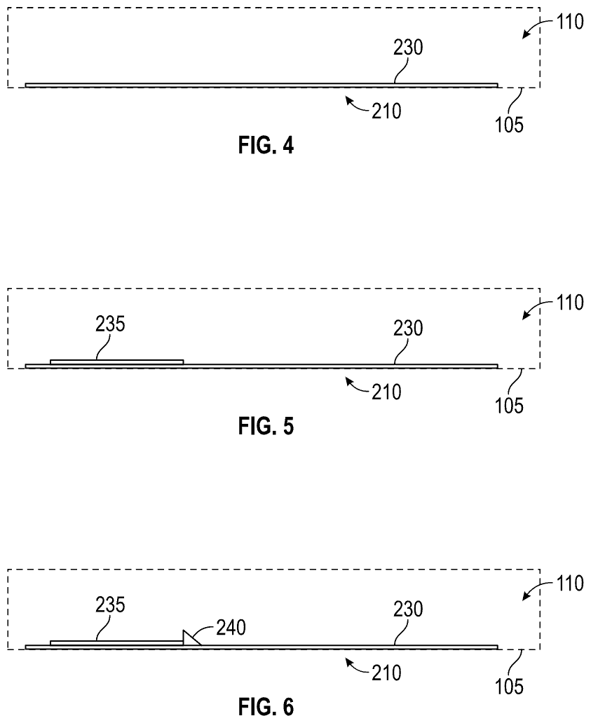

Referring to FIGS. 4-13, a method for securing one or more automobiles 200 within the interior volume 110 of the container 75 is shown, according to an exemplary embodiment. As shown in FIGS. 4-9, each of the front bracing assemblies 210 includes a wheel securing component (e.g., a cord, a rope, strap, etc.), shown as strap 230, a first block (e.g., brace, support, wedge, chock, etc.), shown as base block 235, a first wheel brace (e.g., block, support, wedge, chock, etc.), shown as front wheel brace 240, a second block (e.g., brace, support, wedge, chock, etc.), shown as clamping block 245, and a first side brace (e.g., block, support, wedge, chock, etc.), shown as front wheel side brace 250.

As shown in FIG. 4, the first step of the method for securing the automobile 200 within the interior volume 110 of the container 75 includes laying two of the straps 230 along the interior surface of the bottom wall 105 of the container 75 such that the ends of the straps 230 extend in a longitudinal direction. By way of example, the front end of the straps 230 may be positioned proximate the front wall 90 of the container 75. In some embodiments, the front ends of the straps 230 are positioned about 2 inches from the front wall 90. In other embodiments, the front ends of the straps 230 are positioned more or less than 2 inches from the front wall 90. According to an exemplary embodiment, the straps 230 are laterally spaced a distance apart to accommodate the distance W or wheel track of the automobile 200. The straps 230 may be manufactured from a polyester material approved for automobile transportation applications. In some embodiments, the straps 230 are 1.25 inch wide American Association of Railroads (AAR) approved Grade IV Cord Strapping. In other embodiments, the straps 230 are manufactured from a different material and approved for automobile transportation applications by another organization. According to an exemplary embodiment, the length of the straps 230 extending in the longitudinal direction is at least 120 inches. In some embodiments, the straps 230 are otherwise sufficiently sized (e.g., at least 100 inches, at least 110 inches, etc.) to facilitate extending from under the base block 235, around the front wheels 220, and under the clamping block 245 to secure the automobile 200 during transportation. The routing of the strap 230 to secure the automobile 200 is described in greater detail with reference to FIGS. 5-9.

As shown in FIG. 5, the next step of the method for securing the automobile 200 within the interior volume 110 of the container 75 includes placing the base blocks 235 on top of the straps 230 proximate the front ends thereof. In some embodiments, the base blocks 235 are 2 inch by 6 inch by 30 inch hardwood blocks. In other embodiments, the base blocks 235 have other suitable dimensions. In some embodiments, the base blocks 235 are manufactured from another material configured to help prevent the automobile 200 from moving during transportation such as rubber, a plastic (e.g., high-density polyethylene, etc.), a metal (e.g., aluminum alloy), or any other suitable material. The base blocks 235 may be positioned about 2 inches from the front wall 90. In some embodiments, the base blocks 235 are positioned more or less than 2 inches from the front wall 90 (e.g., in contact with the front wall 90). The base blocks 235 are configured to lay on top of the straps 230 such that the length of the base block 235 extends in a longitudinal direction along a similar length of the straps 230 (e.g., 30 inches). The base blocks 235 and the front ends of the straps 230 are coupled to the bottom wall 105 using one or more fasteners (e.g., nails, screws, clamps, etc.). The fasteners may include nails (e.g., between 16d and 20d nails) having a minimum length of 3 inches. The nails may be driven through the base blocks 235 and the straps 230 such that the base blocks 235 fixedly couple the straps 230 to the interior surface of the bottom wall 105. In some embodiments, the base blocks 235 fixedly couple the straps 230 to the interior surface of the bottom wall 105 using another fastening method (e.g., brackets, bolts, screws, adhesives, dowels, clamps, braces, etc.). The base blocks 235 and the straps 230 are positioned and coupled to the container 75 such that they are aligned or substantially aligned with a center (e.g., as viewed from a top view) of the front wheels 220 of the automobile 200. In some embodiments, the base blocks 235 are otherwise suitably dimensioned and/or positioned to sufficiently prevent the automobile 200 from moving during transportation, and to fixedly couple the strap 230 to the interior surface of the bottom wall 105.

As shown in FIG. 6, the next step of the method for securing the automobile 200 within the interior volume 110 of the container 75 includes placing the front wheel braces 240 on top of the straps 230. The front wheel braces 240 are configured to prevent the automobile 200 from moving, rolling, driving, etc. in a longitudinal direction towards the front wall 90 of the container 75. In some embodiments, the front wheel braces 240 are 2 inch by 6 inch by 24 inch hardwood blocks. In some embodiments, the front wheel braces 240 are manufactured from another material configured to help prevent the automobile 200 from moving during transportation such as rubber, a plastic (e.g., high-density polyethylene, etc.), a metal (e.g., aluminum alloy), or any other suitable material. The front wheel braces 240 are positioned proximate the end of the base block 235 that faces the rear wall 95. According to an exemplary embodiment, each of the front wheel braces 240 is positioned to contact the rear end of one of the base blocks 235 and one of the side walls (e.g., the left wall 80 or the right wall 85). The front wheel braces 240 extend in a lateral direction from and perpendicular to the side wall (e.g., perpendicular to the base block 235, the clamping blocks 245, and the front wheel side brace 250). According to the exemplary embodiment shown in FIG. 6, the front wheel braces 240 are beveled (e.g., tapered, rounded, k-beveled, angled, slanted, etc.) to limit direct 90-degree contact with the front wheel 220. In some embodiments, front wheel braces 240 are not beveled. The front wheel braces 240 are coupled to the interior surface of the bottom wall 105 using one or more fasteners (e.g., nails, screws, clamps, etc.). The fasteners may include nails (e.g., between 16d and 20d nails) having a minimum length of 3 inches. The nails may be driven through the front wheel braces 240 such that the front wheel braces 240 are fixedly coupled to the interior surface of the bottom wall 105. In some embodiments, the front wheel braces 240 are fixedly coupled to the bottom wall 105 using another fastening method (e.g., brackets, bolts, screws, adhesives, dowels, clamps, braces, etc.). In some embodiments, front wheel braces 240 are otherwise suitably dimensioned and/or positioned to sufficiently prevent the automobile 200 from moving during transportation.

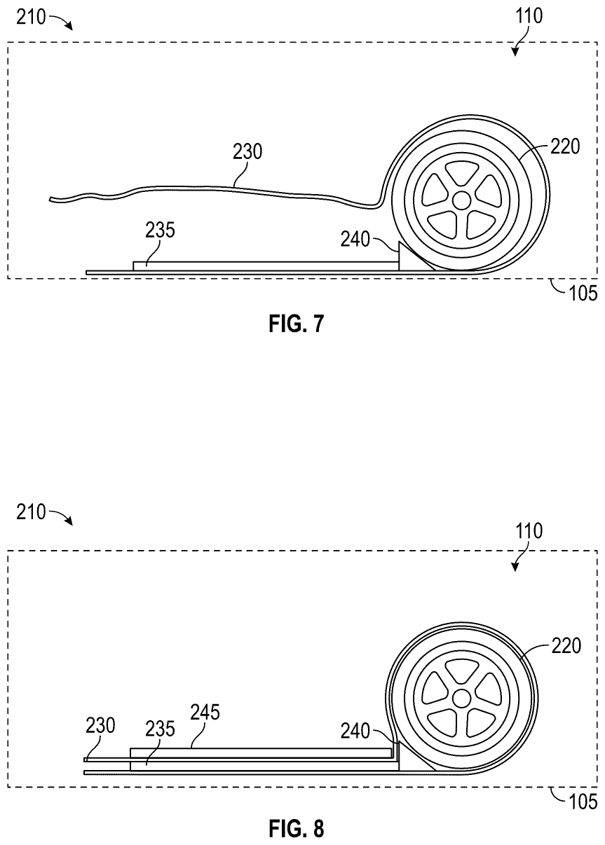

As shown in FIG. 7, the next step of the method for securing the automobile 200 within the interior volume 110 of the container 75 includes loading (e.g., moving, positioning, etc.) the automobile 200 into the interior volume 110. The automobile 200 is loaded such that the front wheels 220 contact the front wheel braces 240 and are positioned on top of a portion of the straps 230 that were laid out in the first step of the method. The free portions of the straps 230 are then wrapped around the outer circumference of the front wheels 220. The free portions of the straps 230 are then laid on top of and extend along at least a portion of the base blocks 235 in the longitudinal direction. In some embodiments, the free ends of the straps 230 extend past the front edge of the base blocks 235.

As shown in FIG. 8, the next step of the method for securing the automobile 200 within the interior volume 110 of the container 75 includes placing the clamping blocks 245 on top of the straps 230 and the base blocks 235. The clamping blocks 245 are configured to fixedly couple the straps 230 between the base blocks 235 and the clamping blocks 245 such that the straps 230 are tightly secured around the outer circumference of the front wheels 220. In some embodiments, the clamping blocks 245 are nominal 2 inch by 6 inch by 30 inch hardwood blocks. In other embodiments, the clamping blocks 245 have other suitable dimensions. In some embodiments, the base blocks 235 are manufactured from another material configured to help prevent the automobile 200 from moving during transportation such as rubber, a plastic (e.g., high-density polyethylene, etc.), a metal (e.g., aluminum alloy), or any other suitable material. The clamping blocks 245 may be oriented substantially similarly as the base blocks 235 and positioned such that the straps 230 are secured between the base blocks 235 and the clamping blocks 245. The clamping blocks 245 are coupled to the base blocks 235 using one or more fasteners (e.g., nails, screws, clamps, etc.). The fasteners may include nails (e.g., between 16d and 20d nails) having a minimum length of 3 inches. The nails may be driven through the clamping blocks 245 and the straps 230 and into the base blocks 235 such that the clamping blocks 245 fixedly couple the straps 230 between the base blocks 235 and the clamping blocks 245. In some embodiments, the clamping blocks 245 fixedly couple the straps 230 between the base blocks 235 and the clamping blocks 245 using another fastening method (e.g., brackets, bolts, screws, adhesives, dowels, clamps, braces, etc.). In some embodiments, the clamping blocks 245 are otherwise suitably dimensioned and/or positioned to sufficiently secure the straps 230 in position around the front wheels 220 and prevent the automobile 200 from moving during transportation.

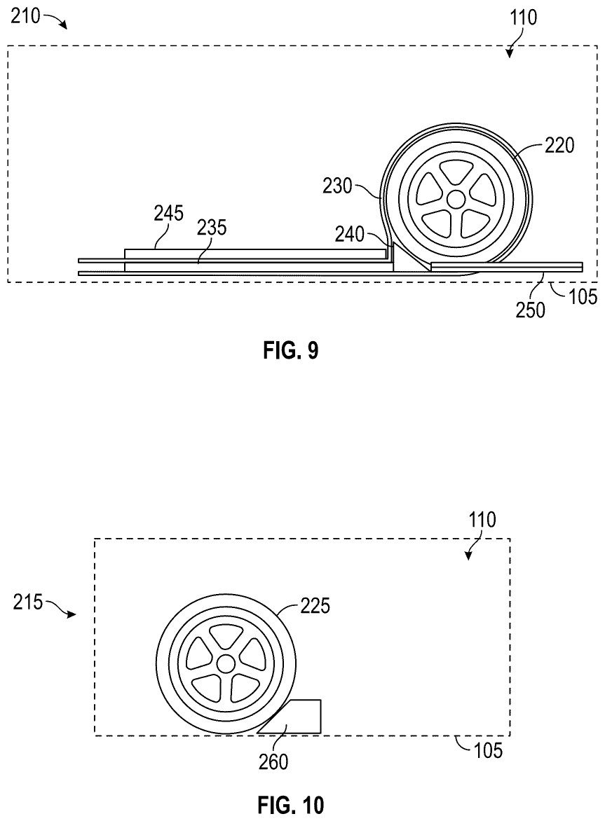

As shown in FIG. 9, the next step of the method for securing the automobile 200 within the interior volume 110 of the container 75 includes placing the front wheel side braces 250 along an outside surface of the front wheels 220. The front wheel side braces 250 are configured to prevent the automobile 200 from moving, rolling, sliding, etc. in a lateral direction towards the side walls (e.g., left wall 80, right wall 85) of the container 75. In some embodiments, each of the front wheel side braces 250 includes two nominal 2 inch by 6 inch by 30 inch hardwood blocks stacked together. In some embodiments, each of the front wheel side braces 250 includes more or fewer than two pieces (e.g., a single piece, three pieces, etc.). In some embodiments, the front wheel side braces 250 are manufactured from another material configured to help prevent the automobile 200 from moving during transportation such as rubber, a plastic (e.g., high-density polyethylene, etc.), a metal (e.g., aluminum alloy), or any other suitable material. The front wheel side braces 250 extend in a longitudinal direction rearward from the front wheel braces 240. The front wheel side braces 250 are positioned to contact the front wheel braces 240. In some embodiments, the front wheel side braces 250 are also positioned to contact the outside surface of the front wheels 220. In other embodiments, the front wheel side braces 250 are positioned proximate the outside surface of the front wheels 220, but not in direct contact therewith, to substantially prevent lateral movement of the automobile 200. In some embodiments, the front wheel side braces 250 are cut or otherwise shaped to match the bevel of the front wheel braces 240. By way of example, the front wheel side braces 250 may be cut such that the surfaces of the front wheel side braces 250 contacting the front wheel braces 240 match (e.g., are parallel with, are complimentary to, etc.) the beveled surface of the front wheel braces 240. A first piece of the front wheel side braces 250 is fixedly coupled to the interior surface of the bottom wall 105 using one or more fasteners (e.g., nails, screws, clamps, etc.). A second piece of the front wheel side braces 250 is fixedly coupled to a top surface of the first piece of the front wheel side braces 250 using one or more fasteners (e.g., nails, screws, clamps, etc.). In some embodiments, the first and second pieces of the front wheel side braces 250 are coupled to the interior surface of the bottom wall 105 using a single set of fasteners that extend through or couple to both. The fasteners may include nails (e.g., between 16d and 20d nails) having a minimum length of 3 inches. In some embodiments, the front wheel side braces 250 are fixedly coupled to the interior surface of the bottom wall 105 using another fastening method (e.g., brackets, bolts, screws, adhesives, dowels, clamps, braces, etc.). In some embodiments, front wheel side braces 250 are otherwise suitably dimensioned and/or positioned to sufficiently prevent the automobile 200 from moving during transportation.

Referring to FIGS. 10-13, the method for securing the rear wheels 225 of one or more automobiles 200 within the interior volume 110 of the container 75 is shown, according to an exemplary embodiment. Each of the rear bracing assemblies 215 includes a second wheel brace (e.g., block, support, wedge, chock, etc.), shown as rear wheel brace 260, a second side brace (e.g., block, support, wedge, chock, etc.), shown as rear wheel side brace 265, a backup cleat (e.g., block, support, wedge, chock, etc.), shown as backup cleat 270, and a support brace (e.g., cross support, transverse brace, etc.), shown as cross brace 275.

As shown in FIG. 10, the next step of the method for securing the automobile 200 within the interior volume 110 of the container 75 includes placing the rear wheel braces 260 behind the rear wheels 225. The rear wheel braces 260 are configured to prevent the automobile 200 from moving, rolling, driving, etc. in a longitudinal direction towards the rear wall 95 of the container 75. The rear wheel braces 260 are nominal 2 inch by 6 inch by 24 inch hardwood blocks. In some embodiments, the rear wheel braces 260 are manufactured from another material configured to help prevent the automobile 200 from moving during transportation such as rubber, a plastic (e.g., high-density polyethylene, etc.), a metal (e.g., aluminum alloy), or any other suitable material. The rear wheel braces 260 are positioned to contact the rear wheels 225 and one of the side walls (e.g., the left wall 80 or the right wall 85). The rear wheel braces 260 extend in a lateral direction from and perpendicular to the side wall (e.g., perpendicular to the rear wheel side braces 265 and the backup cleats 270). According to the exemplary embodiment shown in FIG. 10, the rear wheel braces 260 are beveled (e.g., tapered, rounded, k-beveled, angled, slanted, etc.) to limit direct 90-degree contact with the rear wheels 225. In some embodiments, rear wheel braces 260 are not beveled. The rear wheel braces 260 are coupled to the interior surface of the bottom wall 105 using one or more fasteners (e.g., nails, screws, clamps, etc.). The fasteners may include nails (e.g., between 16d and 20d nails) having a minimum length of 3 inches. The nails may be driven through the rear wheel braces 260 such that the rear wheel braces 260 are fixedly coupled to the interior surface of the bottom wall 105. In some embodiments, the rear wheel braces 260 are fixedly coupled to the bottom wall 105 using another fastening method (e.g., brackets, bolts, screws, adhesives, dowels, clamps, braces, etc.). In some embodiments, rear wheel braces 260 are otherwise suitably dimensioned and/or positioned to sufficiently prevent the automobile 200 from moving during transportation.

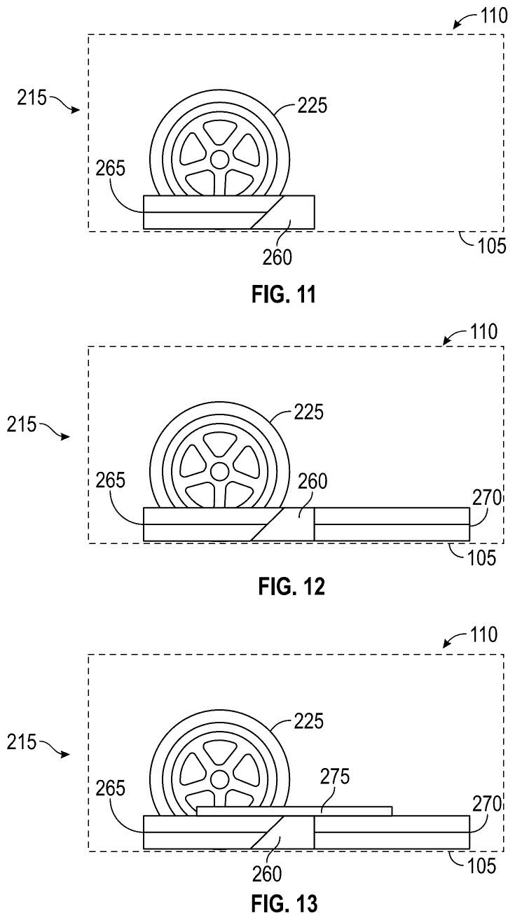

As shown in FIG. 11, the next step of the method for securing the automobile 200 within the interior volume 110 of the container 75 includes placing the rear wheel side braces 265 along the outside surface of the rear wheels 225. The rear wheel side braces 265 are configured to prevent the automobile 200 from moving, rolling, sliding, etc. in a lateral direction towards the side walls (e.g., left wall 80, right wall 85) of the container 75. In some embodiments, each of the rear wheel side braces 265 includes two nominal 2 inch by 6 inch by 30 inch hardwood blocks coupled together. In some embodiments, each of the rear wheel side braces 265 includes more or fewer than two pieces. In some embodiments, the rear wheel side braces 265 are manufactured from another material configured to help prevent the automobile 200 from moving during transportation such as rubber, a plastic (e.g., high-density polyethylene, etc.), a metal (e.g., aluminum alloy), or any other suitable material. The rear wheel side braces 265 are positioned to contact the rear wheel braces 260. The rear wheel side braces 265 extend in a longitudinal direction forward from the rear wheel braces 260. In some embodiments, the rear wheel side braces 265 are also positioned to contact the outside surfaces of the rear wheels 225. In other embodiments, the rear wheel side braces 265 are positioned proximate the outside surface of the rear wheels 225, but not in direct contact therewith, to substantially prevent lateral movement of the automobile 200. In some embodiments, the rear wheel side braces 265 are cut or otherwise shaped to match the beveled surface of the rear wheel braces 260. By way of example, the rear wheel side braces 265 may be cut such that the surfaces of the rear wheel side braces 265 contacting the rear wheel braces 260 match (e.g., parallel with, complimentary to, etc.) the bevel of the rear wheel braces 260. A first piece of the rear wheel side braces 265 is fixedly coupled to the interior surface of the bottom wall 105 using one or more fasteners (e.g., nails, screws, clamps, etc.). A second piece of the rear wheel side braces 265 is fixedly coupled to a top surface of the first piece of the rear wheel side braces 265 using one or more fasteners (e.g., nails, screws, clamps, etc.). In some embodiments, the first and second pieces of the rear wheel side braces 265 are coupled to the interior surface of the bottom wall 105 using a single set of fasteners that extend through or couple to both. The fasteners may include nails (e.g., between 16d and 20d nails) having a minimum length of 3 inches. In some embodiments, the rear wheel side braces 265 are fixedly coupled to the bottom wall 105 using another fastening method (e.g., brackets, bolts, screws, adhesives, dowels, clamps, braces, etc.). In some embodiments, the rear wheel side braces 265 are otherwise suitably dimensioned and/or positioned to sufficiently prevent the automobile 200 from moving during transportation.

As shown in FIG. 12, the next step of the method for securing the automobile 200 within the interior volume 110 of the container 75 includes placing the backup cleats 270 behind the rear wheel braces 260. The backup cleats 270 are configured to provide support to the rear side of the rear wheel braces 260 to prevent the automobile 200 and the rear wheel braces 260 from moving, rolling, sliding, etc. in a longitudinal direction towards the rear wall 95 of the container 75. In some embodiments, each of the backup cleats 270 includes two nominal 2 inch by 6 inch by 30 inch hardwood blocks coupled together. In some embodiments, the backup cleats 270 include more or fewer than two pieces. In some embodiments, the backup cleats 270 are manufactured from another material configured to help prevent the automobile 200 from moving during transportation such as rubber, a plastic (e.g., high-density polyethylene, etc.), a metal (e.g., aluminum alloy), or any other suitable material. The backup cleats 270 are positioned to contact a rear side of the rear wheel braces 260 and extend in a longitudinal direction rearward from the rear wheel braces 260. The backup cleats 270 are positioned such that they are aligned or substantially aligned with the rear wheel side braces 265 (e.g., along a common longitudinal axis) and spaced a width of the rear wheel braces 260 from the rear wheel side braces 265. A first piece of the backup cleats 270 is fixedly coupled to the interior surface of the bottom wall 105 using one or more fasteners (e.g., nails, screws, clamps, etc.). A second piece of the backup cleats 270 is fixedly coupled to a top surface of the first piece of the backup cleats 270 using one or more fasteners (e.g., nails, screws, clamps, etc.). In some embodiments, the first and second pieces of the backup cleats 270 are coupled to the interior surface of the bottom wall 105 using a single set of fasteners that extend through or couple to both. The fasteners may include nails (e.g., between 16d and 20d nails) having a minimum length of 3 inches. In some embodiments, the backup cleats 270 are fixedly coupled to the bottom wall 105 using another fastening method (e.g., brackets, bolts, screws, adhesives, dowels, clamps, braces, etc.). In some embodiments, backup cleats 270 are otherwise suitably dimensioned and/or positioned to sufficiently prevent the automobile 200 from moving during transportation.

As shown in FIG. 13, the next step of the method for securing the automobile 200 within the interior volume 110 of the container 75 includes placing the cross braces 275 on top of the top surfaces of the rear wheel braces 260, the rear wheel side braces 265, and the backup cleats 270. The cross braces 275 are configured to provide structural stability to the various components of the rear bracing assemblies 215 to prevent the automobile 200 from moving, rolling, sliding, etc. in a lateral and/or longitudinal direction. In some embodiments, the cross braces 275 are nominal 2 inch by 6 inch by 30 inch hardwood blocks. In some embodiments, the cross braces 275 are manufactured from another material configured to help provide structural stability to the various components of the rear bracing assemblies 215 such as a plastic (e.g., high-density polyethylene, etc.), a metal (e.g., aluminum alloy), or any other suitable material. The cross braces 275 extend in a longitudinal direction along the top surfaces of the rear wheel braces 260, the rear wheel side braces 265, and the backup cleats 270. The cross braces 275 are coupled to top surfaces of the rear wheel braces 260, the rear wheel side braces 265, and the backup cleats 270 using one or more fasteners (e.g., nails, screws, clamps, etc.) to provide structural stability to the rear bracing assemblies 215 during transportation. The fasteners may include nails (e.g., between 16d and 20d nails) having a minimum length of 3 inches. In some embodiments, the cross braces 275 are fixedly coupled to the top surfaces of the rear wheel braces 260, the rear wheel side braces 265, and the backup cleats 270 using another fastening method (e.g., brackets, bolts, screws, adhesives, dowels, clamps, braces, etc.). In some embodiments, cross braces 275 are otherwise suitably dimensioned and/or positioned to sufficiently provide structural stability to the rear bracing assemblies 215 during transportation.

The method for securing the automobile 200 within the interior volume 110 of the container 75 shown in FIGS. 4-13 and described above is repetitively applied to both the left and right sides of the automobile 200. Specifically, the front bracing assemblies 210 are installed to secure the left and right front wheels 220 of the automobile 200 and the rear bracing assemblies 215 are installed to secure the left and right rear wheels 225 of the automobile 200. Applying the securing method as disclosed herein to both the left and right sides of the automobile 200 ensures symmetrically securing the automobile 200 in the container 75 to prevent movement of and damage to the automobile 200 during transit.

Additionally, the method for securing the automobile 200 may be repetitively and successively applied to more than one automobile 200, ensuring that each automobile 200 is secured within the container 75 until the container 75 reaches its optimal capacity (e.g., within weigh regulations). As shown in FIGS. 2 and 3, the container 75 is configured to secure (e.g., by way of the automobile securing system 205) three automobiles 200. Depending on the size and configuration of the container 75 and/or the automobiles 200, more or fewer than three automobiles 200 may be secured inside the container 75.

The automobile securing system 205 and method for applying the automobile securing system 205 provides various advantages over traditional automobile transportation systems. The front bracing assemblies 210 and the rear bracing assemblies 215 are comprised of a plurality of components (e.g., the base blocks 235, the front wheel braces 240, the clamping blocks 245, the front wheel side braces 250, the rear wheel braces 260, the rear wheel side braces 265, the backup cleats 270, and the cross braces 275) configured to secure the automobile 200 during transportation. In some embodiments, the plurality of components are manufactured and cut from pieces of the material (e.g., wood) having the same dimensions (e.g., 2 inches by 6 inches). In such embodiments, having the same dimensions ensures consistency in the size and appearance of the components, reduces the amount of waste during manufacturing and assembly, simplifies the construction of the front bracing assemblies 210 and the rear bracing assemblies 215, simplifies the execution of the method, makes repairs, modifications, and upgrades to the automobile securing system 205 easier, and reduces the overall cost to manufacture and assemble the automobile securing system 205. Additionally, repetitively applying the method for securing one or more automobiles 200 using the automobile securing system 205 provides a systematic and repeatable solution for the transportation of the automobiles 200. The automobile securing system 205 is adaptable to accommodate automobiles 200 having various sizes and configurations, which provides further advantages during the transportation of the automobiles 200.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

It is important to note that the construction and arrangement of the vehicle 10 and automobile securing system 205 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. An automobile securing system for securing an automobile inside a container of a truck, the automobile securing system comprising:
a front bracing assembly configured to couple to a bottom wall of the container, the front bracing assembly configured to secure a front wheel of the automobile inside the container, the front bracing assembly including:
a strap configured to wrap around the front wheel;
a base block and a clamping block configured to be positioned in front of the front wheel and secure a portion of the strap therebetween;
a front wheel brace configured to engage the front wheel and a side wall of the container, the front wheel brace configured to be positioned to prevent forward movement of the automobile; and
a front wheel side brace configured to be positioned to prevent lateral movement of the automobile; and
a rear bracing assembly configured to couple to the bottom wall of the container, the rear bracing assembly configured to secure a rear wheel of the automobile inside the container, the rear bracing assembly including:
a rear wheel brace configured to engage the rear wheel and the side wall of the container, the rear wheel brace configured to be positioned to prevent rearward movement of the automobile;
a rear wheel side brace configured to be positioned to prevent lateral movement of the automobile;
a backup cleat configured to engage a rear side of the rear wheel brace; and
a cross brace configured to couple the rear wheel brace, the rear wheel side brace, and the backup cleat together.

2. The automobile securing system of claim 1, wherein the front wheel is a first front wheel and the front bracing assembly is a first front bracing assembly configured to secure the first front wheel, wherein the rear wheel is a first rear wheel and the rear bracing assembly is a first rear bracing assembly configured to secure the first rear wheel, and wherein the automobile securing system includes:
a second front bracing assembly configured to secure a second front wheel of the automobile; and
a second rear bracing assembly configured to secure a second rear wheel of the automobile.

3. The automobile securing system of claim 2, wherein the first front bracing assembly is laterally spaced from the second front bracing assembly by a lateral length of the automobile extending between an outside edge of the first front wheel and an outside edge of the second front wheel, and wherein the first rear bracing assembly is laterally spaced from the second rear bracing assembly by a lateral length of the automobile extending between an outside edge of the first rear wheel and an outside edge of the second rear wheel.

4. The automobile securing system of claim 1, wherein the base block, the clamping block, and the portion of the strap secured therebetween are configured to be positioned to align with a center of the front wheel.

5. The automobile securing system of claim 1, wherein the portion of the strap secured between the base block and the clamping block is a first portion of the strap, and wherein the front wheel brace is configured to be positioned on top of a second portion of the strap.

6. The automobile securing system of claim 5, wherein the base block is configured to be positioned on top of the second portion of the strap.

7. The automobile securing system of claim 1, wherein the front wheel brace is configured to be positioned to engage a front side of the front wheel to prevent forward movement of the automobile.

8. The automobile securing system of claim 1, wherein the rear wheel brace is configured to be positioned to engage a rear side of the rear wheel to prevent rearward movement of the automobile.

9. The automobile securing system of claim 1, wherein the front wheel brace is configured to be positioned to contact a rear end of the base block.

10. The automobile securing system of claim 1, wherein each of the front wheel brace and the rear wheel brace have a beveled surface configured to engage the front wheel or the rear wheel, respectively.

11. The automobile securing system of claim 10, wherein a surface of the front wheel side brace is configured to contact the front wheel brace and the surface matches the beveled surface of the front wheel brace.

12. The automobile securing system of claim 10, wherein a surface of the rear wheel side brace is configured to contact the rear wheel brace and the surface matches the beveled surface of the rear wheel brace.

13. The automobile securing system of claim 1, wherein the front bracing assembly is longitudinally spaced from the rear bracing assembly by a longitudinal length of the automobile between a front edge of the front wheel and a rear edge of the rear wheel.

14. A method for securing a finished automobile inside a container being transported by a truck, the method comprising:
providing a set of front bracing assemblies including straps, base blocks, front wheel braces, clamping blocks, and front wheel side braces;
providing a set of rear bracing assemblies including rear wheel braces, rear wheel side braces, backup cleats, and cross braces;
laying the straps longitudinally along a bottom wall of the container such that the straps are laterally spaced a distance apart based on a wheel track of the finished automobile;
placing the base blocks on top of the straps;
placing the front wheel braces laterally across the straps, the front wheel braces engaging rear ends of the base blocks and side walls of the container;
loading the finished automobile into the container such that front wheels of the finished automobile engage with the front wheel braces;
wrapping free ends of the straps around an outer circumference of the front wheels with the free ends of the straps extending at least partially along upper surfaces of the base blocks;
placing the clamping blocks on top of the free ends of the straps to secure the straps between the base blocks and the clamping blocks;
placing the front wheel side braces along an outside surface of the front wheels;
placing the rear wheel braces laterally behind rear wheels of the finished automobile, the rear wheel braces engaging the rear wheels and the side walls of the container;
placing the rear wheel side braces along an outside surface of the rear wheels forward of and in engagement with front sides of the rear wheel braces;
placing the backup cleats rearward of and in engagement with rear sides of the rear wheel braces; and
coupling the rear wheel braces, the rear wheel side braces, and the backup cleats together using the cross braces.

15. The method of claim 14, wherein the base blocks, the clamping blocks, and portions of the straps secured therebetween are configured to be positioned to align with centers of the front wheels.

16. The method of claim 14, wherein each of the front wheel brace and the rear wheel brace have a beveled surface configured to engage the front wheel or the rear wheel, respectively.

17. The method of claim 16, wherein a surface of the front wheel side brace is configured to contact the front wheel brace and the surface matches the beveled surface of the front wheel brace.

18. The method of claim 16, wherein a surface of the rear wheel side brace is configured to contact the rear wheel brace and the surface matches the beveled surface of the rear wheel brace.

19. An automobile securing system for securing an automobile inside a container of a truck, the automobile securing system comprising:
a plurality of front bracing assemblies configured to couple to a bottom wall of the container, the plurality of front bracing assemblies configured to secure front wheels of the automobile inside the container, each of the plurality of front bracing assemblies including:
a strap configured to wrap around a respective front wheel of the front wheels, the strap including a first portion and a second portion;
a base block and a clamping block configured to be positioned in front of the respective front wheel and secure the first portion of the strap therebetween, the base block configured to be positioned on top of the second portion of the strap; and
a front wheel brace configured to engage the respective front wheel, the front wheel brace configured to be positioned (i) to prevent forward movement of the automobile and (ii) on top of the second portion of the strap; and
a plurality of rear bracing assemblies configured to couple to the bottom wall of the container, the plurality of rear bracing assemblies configured to secure rear wheels of the automobile inside the container, each of the plurality of rear bracing assemblies including:
a rear wheel brace configured to engage a respective rear wheel of the rear wheels, the rear wheel brace configured to be positioned to prevent rearward movement of the automobile;
a backup cleat configured to engage a rear side of the respective rear wheel brace; and
a cross brace configured to couple the rear wheel brace and the backup cleat together.

20. The automobile securing system of claim 19, at least one of the front wheel brace or the rear wheel brace is configured to engage a sidewall of the container.
